(19) United States
(12) Patent Application Publication
(10) Pub. No.: US 2023/0305708 A1
(43) Pub. Date: Sep. 28, 2023

(54) INTERFACE FOR DIFFERENT INTERNAL AND EXTERNAL MEMORY IO PATHS

(71) Applicant: Intel NDTM US LLC, Santa Clara, CA (US)

(72) Inventors: Chang Wan Ha, San Ramon, CA (US); Sriram Balasubrahmanyam, Folsom, CA (US)

(73) Assignee: Intel NDTM US LLC, Santa Clara, CA (US)

(21) Appl. No.: 17/705,051

(22) Filed: Mar. 25, 2022

(51) Int. Cl. G06F 3/06

(52) U.S. Cl. CPC G06F 3/0611; G06F 3/0655; G06F 3/0679

(57) ABSTRACT

An embodiment of an apparatus may include a memory package with one or more memory die on an internal input/output (IO) path of the memory package, and an interface module communicatively coupled to the one or more memory die through the internal IO path, the interface module including circuitry to perform IO external to the memory package at a first IO width and a first IO speed, and perform IO internal to the memory package at a second IO width and a second IO speed, wherein one or more of the second IO width is different from the first IO width and the second IO speed is different from the first IO speed. Other embodiments are disclosed and claimed.

### BACKGROUND

A typical flash memory device may include a memory array that includes a large number of non-volatile memory cells arranged in row and column fashion. In recent years, vertical memory, such as three-dimensional (3D) memory, has been developed in various forms, such as NAND, cross-point, or the like. A 3D flash memory array may include a plurality of memory cells stacked over one another to form a vertical NAND string. Various interconnect standards, such as Peripheral Component Interconnect (PCI), PCI Express (PCIe), Nonvolatile Memory Express (NVMe), etc., describe a connection in terms of a number of data lanes for the connection. When a computer system is first powered on, the system may identify various connections between each device of the system and negotiate the width of each connection. A single PCIe or NVMe slot may include up to sixteen data-transmission lanes, where 1 lane is denoted as x1, 8 lanes is denoted as x8, 16 lanes is denoted as x16, and so on.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a block diagram of an apparatus according to an embodiment;

FIG. 2 is a block diagram of a system according to an embodiment;

FIG. 3 is an illustrative diagram of an example of a method according to an embodiment;

FIG. 4 is a block diagram of an example of a memory system according to an embodiment;

FIGS. 5A to 5C are block diagrams of examples of NAND packages according to embodiments;

FIG. 6 is a block diagram of an example of a computing system according to an embodiment; and

FIG. 7 is a block diagram of an example of a Multi-IO NAND memory device according to an embodiment.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smartphones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, Field Programmable Gate Array (FPGA), firmware, driver, software, or any combination thereof. The material disclosed herein may also be implemented as instructions stored on a machine-readable medium, which may be read and executed by Moore Machine, Mealy Machine, and/or one or more processors. A machine-readable medium may include any medium and/or mechanism for storing or transmitting information in a form readable by a machine (e.g., a computing device). For example, a machine-readable medium may include read only memory (ROM); random access memory (RAM); Dynamic random-access memory (DRAM), magnetic disk storage media; optical storage media; nonvolatile (NV) memory devices; qubit solid-state quantum memory, electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every embodiment may not necessarily include the particular feature, structure, or characteristic. Moreover, such phrases are not necessarily referring to the same implementation. Further, when a particular feature, structure, or characteristic is described in connection with an embodiment, it is submitted that it is within the knowledge of one skilled in the art to effect such feature, structure, or characteristic in connection with other implementations whether or not explicitly described herein.

NV memory (NVM) may be a storage medium that does not require power to maintain the state of data stored by the medium. In one embodiment, the memory device may include a three-dimensional (3D) NAND device. The memory device may refer to the die itself and/or to a packaged memory product. In particular embodiments, a memory component with non-volatile memory may comply with one or more standards promulgated by the JEDEC, or other suitable standard (the JEDEC standards cited herein are available at jedec.org).

Conventional data path design has a same input/output (IO) width and IO speed for both the memory controller and the memory packages connected to the memory controller. An interface chip in between the controller and the memory may provide duty cycle correction and/or timing correction, but both a controller side of the interface chip and a memory package side of the interface chip support the same IO width and IO speed for both the memory controller and the memory packages. Some embodiments may provide technology for an interface module that supports different IO widths and/or IO speeds for internal and external memory IO paths.

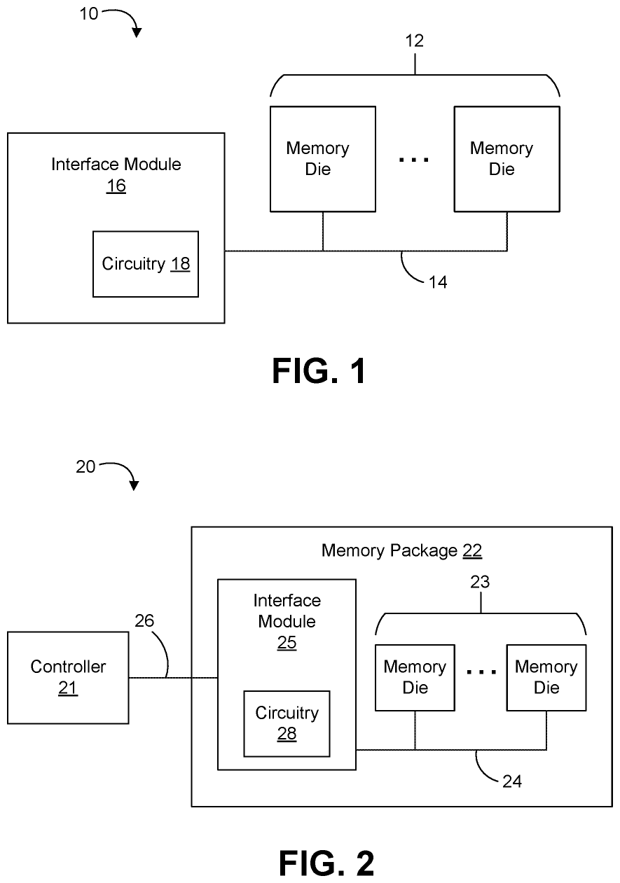

With reference to FIG. 1, an embodiment of an apparatus 10 may include a memory package with one or more memory die 12 on an internal input/output (IO) path 14 of the memory package, and an interface module 16 communicatively coupled to the one or more memory die 12 through the internal IO path 14. The interface module 16 may be configured to provide a suitable interface for a controller to access data stored in the memory die 12, including performing duty cycle correction and/or timing correction. Embodiments of the interface module 16 may further include circuitry 18 to perform IO external to the memory package at a first IO width and a first IO speed, and perform IO internal to the memory package at a second IO width and a second IO speed, where one or more of the second IO width is different from the first IO width and the second IO speed is different from the first IO speed. For example, the circuitry 18 may be configured to convert between external IO at the first IO width and the first IO speed to internal IO at the second IO width and the second IO speed. In some embodiments, the circuitry 18 may comprise multiplexer (mux) and demultiplexer (de-mux) circuitry to convert between external IO at the first IO width and the first IO speed to internal IO at the second IO width and the second IO speed.

In some embodiments, the second IO width may be an integer factor of N times the first IO width and the second IO speed may be the first IO speed divided by N. For example, the circuitry 18 may comprise 2:1 mux and 1:2 de-mux circuitry to convert between external IO and internal IO where the second IO width is two times the first IO width and the second IO speed is one half of the first IO speed. In some embodiments, the memory package may further comprise a package substrate with the one or more memory die 12 and the interface module 16 co-located on the package substrate. In any of the embodiments herein, the one or more memory die 12 may comprise NAND memory die. For example, the NAND memory may comprise three-dimensional 3D NAND memory cells (e.g., strings of floating gate NAND memory cells, strings of charge trap flash (CTF) NAND memory cells, etc.).

Embodiments of each of the above memory die 12, interface module 16, circuitry 18, and other apparatus components may be implemented in hardware, software, or any suitable combination thereof. For example, hardware implementations may include configurable logic, fixed-functionality logic, or any combination thereof. Examples of configurable logic include suitably configured programmable logic arrays (PLAs), FPGAs, complex programmable logic devices (CPLDs), and general purpose microprocessors. Examples of fixed-functionality logic include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, the circuitry 18 may be implemented on a semiconductor apparatus, which may include one or more substrates, with the circuitry 18 coupled to the one or more substrates. In some embodiments, the circuitry 18 may be at least partly implemented in one or more of configurable logic and fixed-functionality hardware logic on semiconductor substrate(s) (e.g., silicon, sapphire, gallium-arsenide, etc.). For example, the circuitry 18 may include a transistor array and/or other integrated circuit components coupled to the substrate(s) with transistor channel regions that are positioned within the substrate(s). The interface between the circuitry 18 and the substrate(s) may not be an abrupt junction. The circuitry 18 may also be considered to include an epitaxial layer that is grown on an initial wafer of the substrate(s).

Alternatively, or additionally, all or portions of these components may be implemented in one or more modules as a set of logic instructions stored in a machine- or computer-readable storage medium such as RAM, ROM, programmable ROM (PROM), firmware, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C #, VHDL, Verilog, System C or the like and conventional procedural programming languages, such as the “C” programming language or similar programming languages. For example, the memory die 12, other persistent storage media, or other system memory may store a set of instructions (e.g., which may be firmware instructions) which when executed by the interface module 16 or other control circuitry cause the apparatus 10 to implement one or more components, features, or aspects of the apparatus 10 (e.g., performing IO external to the memory package at a first IO width and a first IO speed, performing IO internal to the memory package at a second IO width and a second IO speed, etc.).

With reference to FIG. 2, an embodiment of a memory system 20 may include a controller 21, a memory package 22 with one or more memory die 23 on an internal IO path 24 of the memory package 22, and an interface module 25 communicatively coupled to the one or more memory die 23 through the internal IO path 24 and communicatively coupled to the controller 21 on an IO path 26 external to the memory package 22. The interface module 25 may be configured to provide a suitable interface for the controller 21 to access data stored in the memory die 23, including performing duty cycle correction and/or timing correction. The interface module 25 may further include circuitry 28 to perform external IO to the controller 21 at a first IO width and a first IO speed, and perform IO internal to the memory package 22 at a second IO width and a second IO speed, where one or more of the second IO width is different from the first IO width and the second IO speed is different from the first IO speed. For example, the circuitry 28 may be configured to convert between external IO at the first IO width and the first IO speed to internal IO at the second IO width and the second IO speed. In some embodiments, the circuitry 28 may comprise mux and de-mux circuitry to convert between external IO at the first IO width and the first IO speed to internal IO at the second IO width and the second IO speed.

In some embodiments, the second IO width may be an integer factor of N times the first IO width and the second IO speed may be the first IO speed divided by N. For example, the circuitry 28 may comprises 2:1 mux and 1:2 de-mux circuitry to convert between external IO and internal IO where the second IO width is two times the first IO width and the second IO speed is one half of the first IO speed. In some embodiments, the memory package 22 may further comprise a package substrate with the one or more memory die 23 and the interface module 25 co-located on the package substrate. In any of the embodiments herein, the one or more memory die 23 may comprise NAND memory die (e.g., 3D NAND memory).

Embodiments of the controller 21 may include a general purpose controller, a special purpose controller, a memory controller, a storage controller, a NAND controller, a microcontroller, an execution unit, etc. In some embodiments, the memory die 23, the interface module 25, the circuitry 28, and/or other system memory may be located in, or co-located with, various components, including the controller 21 (e.g., on a same die or package substrate). For example, the controller 21 may be configured as a NAND controller and the memory package 22 may be a connected NAND memory device such as a memory module, a nonvolatile dual-inline memory module (NVDIMM), a solid-state drive (SSD), a memory node, etc.

Embodiments of the circuitry 28 may be implemented in a system, apparatus, computer, device, etc., for example, such as those described herein. More particularly, hardware implementations may include configurable logic (e.g., suitably configured PLAs, FPGAs, CPLDs, general purpose microprocessors, etc.), fixed-functionality logic (e.g., suitably configured ASICs, combinational logic circuits, sequential logic circuits, etc.), or any combination thereof. Alternatively, or additionally, the circuitry 28 may be implemented in one or more modules as a set of logic instructions stored in a machine- or computer-readable storage medium such as RAM, ROM, PROM, firmware, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C #, VHDL, Verilog, System C or the like and conventional procedural programming languages, such as the “C” programming language or similar programming languages.

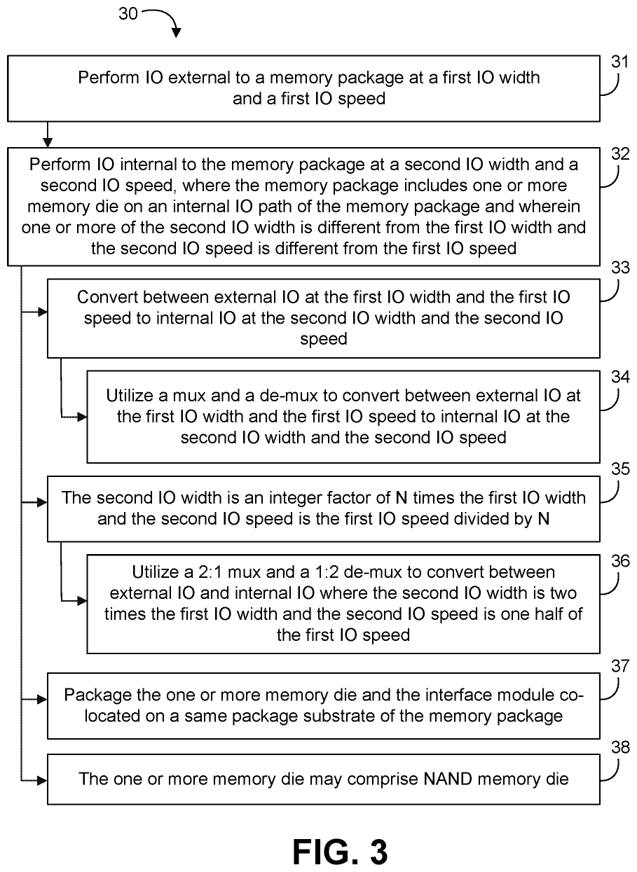

With reference to FIG. 3, an embodiment of a method 30 may include performing IO external to a memory package at a first IO width and a first IO speed at box 31, and performing IO internal to the memory package at a second IO width and a second IO speed at box 32, where the memory package includes one or more memory die on an internal IO path of the memory package and wherein one or more of the second IO width is different from the first IO width and the second IO speed is different from the first IO speed. Some embodiments of the method 30 may include converting between external IO at the first IO width and the first IO speed to internal IO at the second IO width and the second IO speed at box 33. For example, the method 30 may include utilizing a mux and a de-mux to convert between external IO at the first IO width and the first IO speed to internal IO at the second IO width and the second IO speed at box 34.

In some embodiments, the second IO width is an integer factor of N times the first IO width and the second IO speed is the first IO speed divided by N at box 35. For example, the method 30 may include utilizing a 2:1 mux and a 1:2 de-mux to convert between external IO and internal IO where the second IO width is two times the first IO width and the second IO speed is one half of the first IO speed at box 36. Some embodiments of the method 30 may further include packaging the one or more memory die and the interface module co-located on a same package substrate of the memory package at box 37. In some embodiments, the one or more memory die may comprise NAND memory die at box 38.

Embodiments of the method 30 may be implemented in a system, apparatus, computer, device, etc., for example, such as those described herein. More particularly, hardware implementations may include configurable logic (e.g., suitably configured PLAs, FPGAs, CPLDs, general purpose microprocessors, etc.), fixed-functionality logic (e.g., suitably configured ASICs, combinational logic circuits, sequential logic circuits, etc.), or any combination thereof. Hybrid hardware implementations include static dynamic System-on-Chip (SoC) re-configurable devices such that control flow, and data paths implement logic for the functionality. Alternatively, or additionally, the method 30 may be implemented in one or more modules as a set of logic instructions stored in a machine- or computer-readable storage medium such as RAM, ROM, PROM, firmware, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C #, VHDL, Verilog, System C or the like and conventional procedural programming languages, such as the “C” programming language or similar programming languages.

For example, the method 30 may be implemented on a computer readable medium. Embodiments or portions of the method 30 may be implemented in firmware, applications (e.g., through an application programming interface (API)), or driver software running on an OS. Additionally, logic instructions might include assembler instructions, instruction set architecture (ISA) instructions, data set architecture (DSA) commands, (machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, Moore Machine, Mealy Machine, etc.).

Some embodiments provide technology for a NAND system architecture for high-speed input/output (IO). A conventional SSD system may use an IO width of x8 IO per channel. While an IO width of x16 IO per channel may be two times (2×) better in terms of IO throughput as compared to the IO width of x8 IO per channel with the same IO speed, a problem is that using the IO width of x16 IO per channel increases system cost and may require a bigger board area due to the 2× number of IOs per channel. In general, as the number of IO channels increases in a system, the system cost becomes much higher. Accordingly, many systems use x8 IO per channel to keep a lower cost system. Another problem is that as IO speed gets faster to have better read, write throughput in a system, NAND memory may have difficulty meeting the IO speed while keeping low cost and x8 IO. Some embodiments may overcome one or more of the foregoing problems.

Some embodiments may provide technology for a NAND memory package that keeps x8 IO per channel at a system level, while having x16 IO per channel between NAND die and an interface chip. For example, the interface chip may perform 2:1 mux, de-mux to change x16 IO per channel to x8 IO per channel or vice versa. Advantageously, the NAND die may operate at half IO speed with a double IO width (e.g., x16) between the interface chip and the NAND die, which may keep low cost NAND die manufacturing without having full system IO speed of receiving (Rx), transmitting (Tx), and other data path designs.

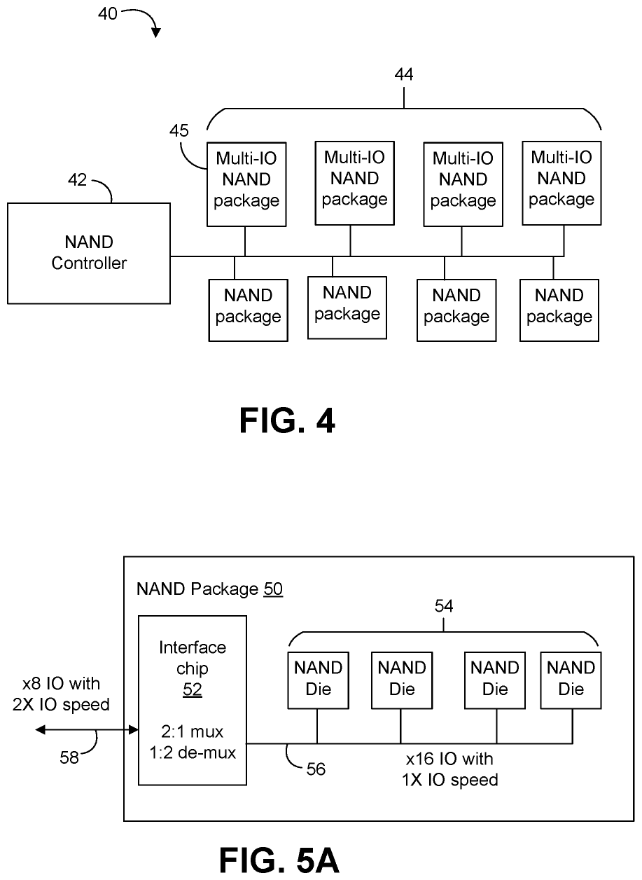

With reference to FIG. 4, an embodiment of a memory system 40 includes a NAND controller 42 coupled to one or more NAND memory packages 44, where at least one of the NAND memory packages 44 includes a Multi-JO NAND package 45. For example, an embodiment of the Multi-JO NAND package 45 may include interface circuitry as described herein to support a different IO width and IO speed internally as compared to a supported IO width and IO speed supported between the Multi-JO NAND package 45 and the NAND controller 42.

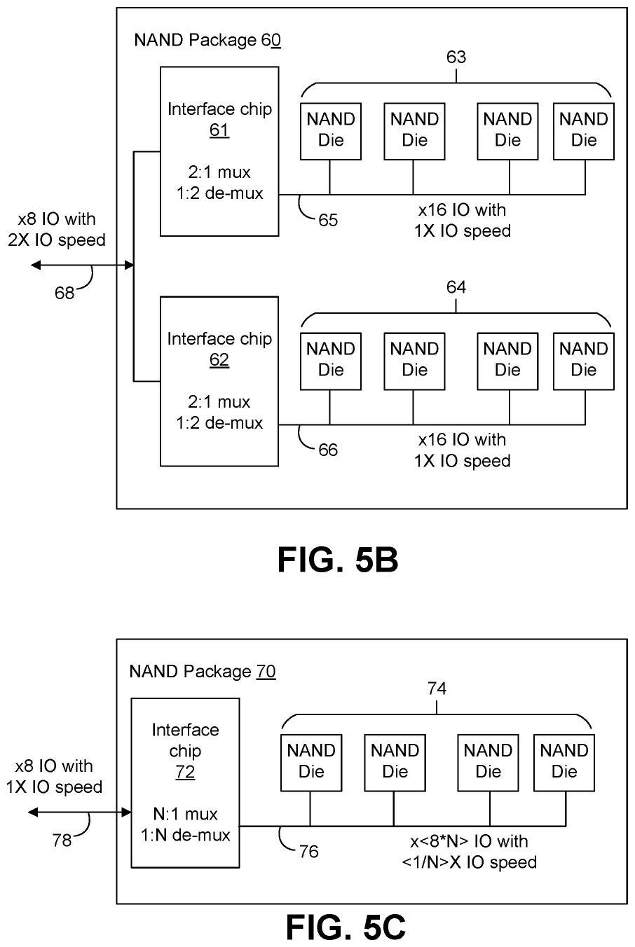

With reference to FIG. 5A, an embodiment of a NAND package 50 may be utilized as the Multi-JO NAND package 45 in the system 40. The NAND package 50 includes an interface chip 52 coupled on a NAND die side of the interface chip 52 to a group of NAND die 54 all on a same IO path 56 internal to the NAND package 50. The interface chip 52 is to be coupled on a controller side to a NAND controller (e.g., the NAND controller 42 in the system 40) on an IO path 58 external to the NAND package 50.

The interface chip 52 may be configured to support different IO widths and/or IO speeds for the controller side of the interface chip 52 as compared to the NAND die side of the interface chip 52. For example, the interface chip 52 may support an x8 IO width with a 2× IO speed on the controller side and an x16 IO width with a 1× IO speed on the NAND die side. The interface chip 52 may provide duty cycle correction and/or timing correction, and may be configured to convert x16 IO to x8 IO and vice versa, to facilitate an at speed data exchange between the NAND controller and the NAND die 54. For example, the interface chip 52 may comprise a 2:1 mux/1:2 de-mux circuit to convert x16 IO to x8 IO and vice versa.

With reference to FIG. 5B, an embodiment of a NAND package 60 may be utilized as the Multi-JO NAND package 45 in the system 40. The NAND package 60 includes two interface chips 61, 62 respectively coupled on a NAND die side of the interface chips 61, 62 to two groups of NAND die 63, 64 all on a IO paths 65, 66 internal to the NAND package 60. The interface chips 61, 62 are to be coupled on a controller side to a NAND controller (e.g., the NAND controller 42 in the system 40) on an IO path 68 external to the NAND package 60.

The interface chips 61, 62 may each be configured to support different IO widths and/or IO speeds for the controller sides of the interface chips 61, 62 as compared to the NAND die sides of the interface chips 61, 62. For example, the interface chips 61, 62 may support an x8 IO width with a 2× IO speed on the controller sides and an x16 IO width with a 1× IO speed on the NAND die sides. The interface chips 61, 62 may provide duty cycle correction and/or timing correction, and may be configured to convert x16 IO to x8 IO and vice versa, to facilitate an at speed data exchange between the NAND controller and the NAND die 63, 64. For example, the interface chips 61, 62 may each comprise a 2:1 mux/1:2 de-mux circuit to convert x16 IO to x8 IO and vice versa.

With reference to FIG. 5C, an embodiment of a NAND package 70 may be utilized as the Multi-JO NAND package 45 in the system 40. The NAND package 70 includes an interface chip 72 coupled on a NAND die side of the interface chip 72 to a group of NAND die 74 all on a same IO path 76 internal to the NAND package 70. The interface chip 72 is to be coupled on a controller side to a NAND controller (e.g., the NAND controller 42 in the system 40) on an IO path 78 external to the NAND package 70.

The interface chip 72 may be configured to support different IO widths and/or IO speeds for the controller side of the interface chip 72 as compared to the NAND die side of the interface chip 72. For example, the interface chip 72 may support an x8 IO width with a 1× IO speed on the controller side and an x<8*N>IO width with a <1/N>X IO speed on the NAND die side, where N is an integer constant greater than zero. The interface chip 72 may provide duty cycle correction and/or timing correction, and may be configured to convert x<8*N>IO to x8 IO and vice versa, to facilitate an at speed data exchange between the NAND controller and the NAND die 74. For example, the interface chip 72 may comprise a N:1 mux/1:N de-mux circuit to convert x<8*N>IO to x8 IO and vice versa.

The technology discussed herein may be provided in various computing systems (e.g., including a non-mobile computing device such as a desktop, workstation, server, rack system, etc., a mobile computing device such as a smartphone, tablet, Ultra-Mobile Personal Computer (UMPC), laptop computer, ULTRABOOK computing device, smart watch, smart glasses, smart bracelet, etc., and/or a client/edge device such as an Internet-of-Things (IoT) device (e.g., a sensor, a camera, etc.)).

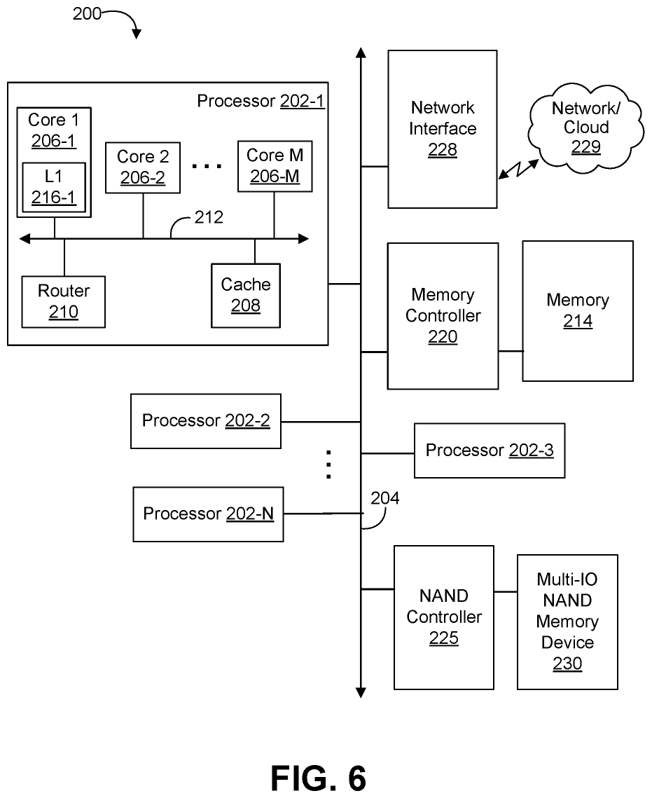

Turning now to FIG. 6, an embodiment of a computing system 200 may include one or more processors 202-1 through 202-N (generally referred to herein as “processors 202” or “processor 202”). The processors 202 may communicate via an interconnection or bus 204. Each processor 202 may include various components some of which are only discussed with reference to processor 202-1 for clarity. Accordingly, each of the remaining processors 202-2 through 202-N may include the same or similar components discussed with reference to the processor 202-1.

In some embodiments, the processor 202-1 may include one or more processor cores 206-1 through 206-M (referred to herein as “cores 206,” or more generally as “core 206”), a cache 208 (which may be a shared cache or a private cache in various embodiments), and/or a router 210. The processor cores 206 may be implemented on a single integrated circuit (IC) chip. Moreover, the chip may include one or more shared and/or private caches (such as cache 208), buses or interconnections (such as a bus or interconnection 212), memory controllers, or other components.

In some embodiments, the router 210 may be used to communicate between various components of the processor 202-1 and/or system 200. Moreover, the processor 202-1 may include more than one router 210. Furthermore, the multitude of routers 210 may be in communication to enable data routing between various components inside or outside of the processor 202-1.

The cache 208 may store data (e.g., including instructions) that is utilized by one or more components of the processor 202-1, such as the cores 206. For example, the cache 208 may locally cache data stored in a memory 214 for faster access by the components of the processor 202. As shown in FIG. 6, the memory 214 may be in communication with the processors 202 via the interconnection 204. In some embodiments, the cache 208 (that may be shared) may have various levels, for example, the cache 208 may be a mid-level cache and/or a last-level cache (LLC). Also, each of the cores 206 may include a level 1 (L1) cache (216-1) (generally referred to herein as “L1 cache 216”). Various components of the processor 202-1 may communicate with the cache 208 directly, through a bus (e.g., the bus 212), and/or a memory controller or hub.

As shown in FIG. 6, memory 214 may be coupled to other components of system 200 through a memory controller 220. Memory 214 may include volatile memory and may be interchangeably referred to as main memory or system memory. Even though the memory controller 220 is shown to be coupled between the interconnection 204 and the memory 214, the memory controller 220 may be located elsewhere in system 200. For example, memory controller 220 or portions of it may be provided within one of the processors 202 in some embodiments. Alternatively, memory 214 may include byte-addressable non-volatile memory such as INTEL OPTANE technology.

The system 200 may communicate with other devices/systems/networks via a network interface 228 (e.g., which is in communication with a computer network and/or the cloud 229 via a wired or wireless interface). For example, the network interface 228 may include an antenna (not shown) to wirelessly (e.g., via an Institute of Electrical and Electronics Engineers (IEEE) 802.11 interface (including IEEE 802.11a/b/g/n/ac, etc.), cellular interface, 3G, 4G, LTE, BLUETOOTH, etc.) communicate with the network/cloud 229.

System 200 may also include NAND memory such as a Multi-IO NAND memory device 230 coupled to the interconnect 204 via NAND controller 225. Hence, NAND controller 225 may control access by various components of system 200 to the Multi-IO NAND memory device 230. Furthermore, even though NAND controller 225 is shown to be directly coupled to the interconnection 204 in FIG. 6, NAND controller 225 can alternatively communicate via a memory/storage bus/interconnect (such as the SATA (Serial Advanced Technology Attachment) bus, Peripheral Component Interconnect (PCI) (or PCI EXPRESS (PCIe) interface), NVM EXPRESS (NVMe), Serial Attached SCSI (SAS), Fiber Channel, etc.) with one or more other components of system 200 (for example where the memory bus is coupled to interconnect 204 via some other logic like a bus bridge, chipset, etc.) Additionally, NAND controller 225 may be incorporated into memory controller logic or provided on a same integrated circuit (IC) device in various embodiments (e.g., on the same circuit board device as the Multi-IO NAND memory device 230 or in the same enclosure as the Multi-IO NAND memory device 230).

Furthermore, NAND controller 225 and/or Multi-IO NAND memory device 230 may be coupled to one or more sensors (not shown) to receive information (e.g., in the form of one or more bits or signals) to indicate the status of or values detected by the one or more sensors. These sensor(s) may be provided proximate to components of system 200 (or other computing systems discussed herein), including the cores 206, interconnections 204 or 212, components outside of the processor 202, Multi-IO NAND memory device 230, SSD bus, SATA bus, NAND controller 225, etc., to sense variations in various factors affecting power/thermal behavior of the system/platform, such as temperature, operating frequency, operating voltage, power consumption, and/or inter-core communication activity, etc.

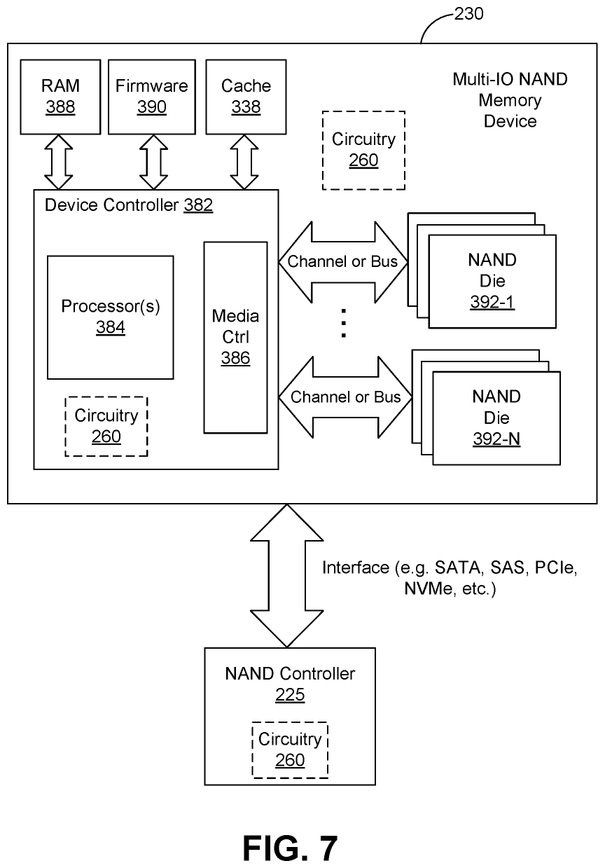

FIG. 7 illustrates a block diagram of various components of the device 230, according to an embodiment. As illustrated in FIG. 7, circuitry 260 may be located in various locations such as inside the device 230 or NAND controller 225. The device 230 includes a device controller 382 (which in turn includes one or more processor cores or processors 384 and media controller logic 386), cache 338, RAM 388, firmware storage 390, and one or more NAND memory dice 392-1 to 392-N (collectively NAND media 392). The NAND media 392 is coupled to the media controller logic 386 via one or more memory channels or busses. Also, device 230 communicates with NAND controller 225 via an interface (such as a SATA, SAS, PCIe, NVMe, etc., interface). Processors 384 and/or device controller 382 may compress/decompress data written to or read from NAND memory dice 392-1 to 392-N.

As illustrated in FIG. 7, the device 230 may include circuitry 260, which may be in the same enclosure as the device 230 and/or fully integrated on a printed circuit board (PCB) of the device 230. One or more of the features/aspects/operations discussed with reference to FIGS. 1-5C may be performed by one or more of the components of FIG. 7. Also, one or more of the features/aspects/operations of FIGS. 1-5C may be programmed into the firmware 390. Further, NAND controller 225 may also include circuitry 260. Advantageously, the circuitry 260 may include technology to implement one or more aspects of the apparatus 10 (FIG. 1), the system 20 (FIG. 2), the method 30 (FIG. 3), the system 40 (FIG. 4), the example NAND packages 50, 60, 70 (FIGS. 5A to 5C), and/or any of the features discussed herein.

For example, the circuitry 260 may be configured to provide a suitable interface for the NAND controller 225 to access data stored in the NAND media 392, including performing duty cycle correction and/or timing correction. The circuitry 260 may be further configured to perform external IO to the NAND controller 225 at a first IO width and a first IO speed, and perform IO internal to the memory package 22 at a second IO width and a second IO speed, where one or more of the second IO width is different from the first IO width and the second IO speed is different from the first IO speed. For example, the circuitry 260 may be configured to convert between external IO at the first IO width and the first IO speed to internal IO at the second IO width and the second IO speed. In some embodiments, the circuitry 260 may comprise mux and de-mux circuitry to convert between external IO at the first IO width and the first IO speed to internal IO at the second IO width and the second IO speed.

In some embodiments, the second IO width may be an integer factor of N times the first IO width and the second IO speed may be the first IO speed divided by N. For example, the circuitry 260 may comprises 2:1 mux and 1:2 de-mux circuitry to convert between external IO and internal IO where the second IO width is two times the first IO width and the second IO speed is one half of the first IO speed. In some embodiments, the Multi-JO NAND memory device 230 may further comprise a package substrate with the NAND media 392 and the circuitry 260 co-located on the package substrate. In some embodiments, the NAND media 392 may comprise 3D NAND memory.

Those skilled in the art will appreciate that a wide variety of devices may benefit from the foregoing embodiments. The following exemplary core architectures, processors, and computer architectures are non-limiting examples of devices that may beneficially incorporate embodiments of the technology described herein.

### Additional Notes and Examples

Example 1 includes an apparatus, comprising a memory package with one or more memory die on an internal input/output (IO) path of the memory package, and an interface module communicatively coupled to the one or more memory die through the internal IO path, the interface module including circuitry to perform IO external to the memory package at a first IO width and a first IO speed, and perform IO internal to the memory package at a second IO width and a second IO speed, wherein one or more of the second IO width is different from the first IO width and the second IO speed is different from the first IO speed.

Example 2 includes the apparatus of Example 1, wherein the circuitry is further to convert between external IO at the first IO width and the first IO speed to internal IO at the second IO width and the second IO speed.

Example 3 includes the apparatus of Example 2, wherein the circuitry comprises multiplexer and demultiplexer circuitry to convert between external IO at the first IO width and the first IO speed to internal IO at the second IO width and the second IO speed.

Example 4 includes the apparatus of any of Examples 1 to 3, wherein the second IO width is an integer factor of N times the first IO width and the second IO speed is the first IO speed divided by N.

Example 5 includes the apparatus of Example 4, wherein the circuitry comprises 2:1 multiplexer and 1:2 demultiplexer circuitry to convert between external IO and internal IO where the second IO width is two times the first IO width and the second IO speed is one half of the first IO speed.

Example 6 includes the apparatus of any of Examples 1 to 5, wherein the memory package further comprises a package substrate with the one or more memory die and the interface module co-located on the package substrate.

Example 7 includes the apparatus of any of Examples 1 to 6, wherein the one or more memory die comprises NAND memory die.

Example 8 includes a memory system, comprising a controller, a memory package with one or more memory die on an internal input/output (IO) path of the memory package, and an interface module communicatively coupled to the one or more memory die through the internal IO path and communicatively coupled to the controller on an IO path external to the memory package, the interface module including circuitry to perform external IO to the controller at a first IO width and a first IO speed, and perform IO internal to the memory package at a second IO width and a second IO speed, wherein one or more of the second IO width is different from the first IO width and the second IO speed is different from the first IO speed.

Example 9 includes the system of Example 8, wherein the circuitry is further to convert between external IO at the first IO width and the first IO speed to internal IO at the second IO width and the second IO speed.

Example 10 includes the system of Example 9, wherein the circuitry comprises multiplexer and demultiplexer circuitry to convert between external IO at the first IO width and the first IO speed to internal IO at the second IO width and the second IO speed.

Example 11 includes the system of any of Examples 8 to 10, wherein the second IO width is an integer factor of N times the first IO width and the second IO speed is the first IO speed divided by N.

Example 12 includes the system of Example 11, wherein the circuitry further comprises 2:1 multiplexer and 1:2 demultiplexer circuitry to convert between external IO and internal IO where the second IO width is two times the first IO width and the second IO speed is one half of the first IO speed.

Example 13 includes the system of any of Examples 8 to 12, wherein the memory package further comprises a package substrate with the one or more memory die and the interface module co-located on the package substrate.

Example 14 includes the system of any of Examples 8 to 13, wherein the one or more memory die comprises NAND memory die.

Example 15 includes a method, comprising performing input/output (IO) external to a memory package at a first IO width and a first IO speed, and performing IO internal to the memory package at a second IO width and a second IO speed, wherein the memory package includes one or more memory die on an internal IO path of the memory package and wherein one or more of the second IO width is different from the first IO width and the second IO speed is different from the first IO speed.

Example 16 includes the method of Example 15, further comprising converting between external IO at the first IO width and the first IO speed to internal IO at the second IO width and the second IO speed.

Example 17 includes the method of Example 16, further comprising utilizing a multiplexer and a demultiplexer to convert between external IO at the first IO width and the first IO speed to internal IO at the second IO width and the second IO speed.

Example 18 includes the method of any of Examples 15 to 17, wherein the second IO width is an integer factor of N times the first IO width and the second IO speed is the first IO speed divided by N.

Example 19 includes the method of Example 18, further comprising utilizing a 2:1 multiplexer and a 1:2 demultiplexer to convert between external IO and internal IO where the second IO width is two times the first IO width and the second IO speed is one half of the first IO speed.

Example 20 includes the method of any of Examples 15 to 19, further comprising packaging the one or more memory die and the interface module co-located on a same package substrate of the memory package.

Example 21 includes the method of any of Examples 15 to 20, wherein the one or more memory die comprises NAND memory die.

Example 22 includes an apparatus, comprising means for performing input/output (IO) external to a memory package at a first IO width and a first IO speed, and means for performing IO internal to the memory package at a second IO width and a second IO speed, wherein the memory package includes one or more memory die on an internal IO path of the memory package and wherein one or more of the second IO width is different from the first IO width and the second IO speed is different from the first IO speed.

Example 23 includes the apparatus of Example 22, further comprising means for converting between external IO at the first IO width and the first IO speed to internal IO at the second IO width and the second IO speed.

Example 24 includes the apparatus of Example 23, further comprising means for utilizing a multiplexer and a demultiplexer to convert between external IO at the first IO width and the first IO speed to internal IO at the second IO width and the second IO speed.

Example 25 includes the apparatus of any of Examples 22 to 24, wherein the second IO width is an integer factor of N times the first IO width and the second IO speed is the first IO speed divided by N.

Example 26 includes the apparatus of Example 25, further comprising means for utilizing a 2:1 multiplexer and a 1:2 demultiplexer to convert between external IO and internal IO where the second IO width is two times the first IO width and the second IO speed is one half of the first IO speed.

Example 27 includes the apparatus of any of Examples 22 to 26, further comprising means for packaging the one or more memory die and the interface module co-located on a same package substrate of the memory package.

Example 28 includes the apparatus of any of Examples 22 to 27, wherein the one or more memory die comprises NAND memory die.

Example 29 includes at least one non-transitory one machine readable medium comprising a plurality of instructions that, in response to being executed on a computing device, cause the computing device to perform input/output (IO) external to a memory package at a first IO width and a first IO speed, and perform IO internal to the memory package at a second IO width and a second IO speed, wherein the memory package includes one or more memory die on an internal IO path of the memory package and wherein one or more of the second IO width is different from the first IO width and the second IO speed is different from the first IO speed.

Example 30 includes the at least one non-transitory one machine readable medium of Example 29, comprising a plurality of further instructions that, in response to being executed on the computing device, cause the computing device to convert between external IO at the first IO width and the first IO speed to internal IO at the second IO width and the second IO speed.

Example 31 includes the at least one non-transitory one machine readable medium of Example 30, comprising a plurality of further instructions that, in response to being executed on the computing device, cause the computing device to utilize a multiplexer and a demultiplexer to convert between external IO at the first IO width and the first IO speed to internal IO at the second IO width and the second IO speed.

Example 32 includes the at least one non-transitory one machine readable medium of any of Examples 29 to 31, wherein the second IO width is an integer factor of N times the first IO width and the second IO speed is the first IO speed divided by N.

Example 33 includes the at least one non-transitory one machine readable medium of Example 32, comprising a plurality of further instructions that, in response to being executed on the computing device, cause the computing device to utilize a 2:1 multiplexer and a 1:2 demultiplexer to convert between external IO and internal IO where the second IO width is two times the first IO width and the second IO speed is one half of the first IO speed.

Example 34 includes the at least one non-transitory one machine readable medium of any of Examples 29 to 33, wherein the one or more memory die comprises NAND memory die.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrase “one or more of A, B, and C” and the phrase “one or more of A, B, or C” both may mean A; B; C; A and B; A and C; B and C; or A, B and C. Various components of the systems described herein may be implemented in software, firmware, and/or hardware and/or any combination thereof. For example, various components of the systems or devices discussed herein may be provided, at least in part, by hardware of a computing SoC such as may be found in a computing system such as, for example, a smart phone. Those skilled in the art may recognize that systems described herein may include additional components that have not been depicted in the corresponding figures. For example, the systems discussed herein may include additional components such as bit stream multiplexer or de-multiplexer modules and the like that have not been depicted in the interest of clarity.

While implementation of the example processes discussed herein may include the undertaking of all operations shown in the order illustrated, the present disclosure is not limited in this regard and, in various examples, implementation of the example processes herein may include only a subset of the operations shown, operations performed in a different order than illustrated, or additional operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the operations discussed herein and/or any portions the devices, systems, or any module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as IP cores may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

It will be recognized that the embodiments are not limited to the embodiments so described, but can be practiced with modification and alteration without departing from the scope of the appended claims. For example, the above embodiments may include specific combination of features. However, the above embodiments are not limited in this regard and, in various implementations, the above embodiments may include the undertaking only a subset of such features, undertaking a different order of such features, undertaking a different combination of such features, and/or undertaking additional features than those features explicitly listed. The scope of the embodiments should, therefore, be determined with reference to the appended claims, along with the full scope of equivalents to which such claims are entitled.

What is claimed is:

1. An apparatus, comprising:
a memory package with one or more memory die on an internal input/output (IO) path of the memory package; and
an interface module communicatively coupled to the one or more memory die through the internal IO path, the interface module including circuitry to:
perform IO external to the memory package at a first IO width and a first IO speed, and
perform IO internal to the memory package at a second IO width and a second IO speed, wherein one or more of the second IO width is different from the first IO width and the second IO speed is different from the first IO speed.

2. The apparatus of claim 1, wherein the circuitry is further to:
convert between external IO at the first IO width and the first IO speed to internal IO at the second IO width and the second IO speed.

3. The apparatus of claim 2, wherein the circuitry comprises multiplexer and demultiplexer circuitry to convert between external IO at the first IO width and the first IO speed to internal IO at the second IO width and the second IO speed.

4. The apparatus of claim 1, wherein the second IO width is an integer factor of N times the first IO width and the second IO speed is the first IO speed divided by N.

5. The apparatus of claim 4, wherein the circuitry comprises 2:1 multiplexer and 1:2 demultiplexer circuitry to convert between external IO and internal IO where the second IO width is two times the first IO width and the second IO speed is one half of the first IO speed.

6. The apparatus of claim 1, wherein the memory package further comprises:
a package substrate with the one or more memory die and the interface module co-located on the package substrate.

7. The apparatus of claim 1, wherein the one or more memory die comprises NAND memory die.

8. A memory system, comprising:
a controller;
a memory package with one or more memory die on an internal input/output (IO) path of the memory package; and
an interface module communicatively coupled to the one or more memory die through the internal IO path and communicatively coupled to the controller on an IO path external to the memory package, the interface module including circuitry to:
perform external IO to the controller at a first IO width and a first IO speed, and
perform IO internal to the memory package at a second IO width and a second IO speed, wherein one or more of the second IO width is different from the first IO width and the second IO speed is different from the first IO speed.

9. The system of claim 8, wherein the circuitry is further to:
convert between external IO at the first IO width and the first IO speed to internal IO at the second IO width and the second IO speed.

10. The system of claim 9, wherein the circuitry comprises multiplexer and demultiplexer circuitry to convert between external IO at the first IO width and the first IO speed to internal IO at the second IO width and the second IO speed.

11. The system of claim 8, wherein the second IO width is an integer factor of N times the first IO width and the second IO speed is the first IO speed divided by N.

12. The system of claim 11, wherein the circuitry further comprises 2:1 multiplexer and 1:2 demultiplexer circuitry to convert between external IO and internal IO where the second IO width is two times the first IO width and the second IO speed is one half of the first IO speed.

13. The system of claim 8, wherein the memory package further comprises:
a package substrate with the one or more memory die and the interface module co-located on the package substrate.

14. The system of claim 8, wherein the one or more memory die comprises NAND memory die.

15. A method, comprising:
performing input/output (IO) external to a memory package at a first IO width and a first IO speed; and
performing IO internal to the memory package at a second IO width and a second IO speed, wherein the memory package includes one or more memory die on an internal IO path of the memory package and wherein one or more of the second IO width is different from the first IO width and the second IO speed is different from the first IO speed.

16. The method of claim 15, further comprising:
converting between external IO at the first IO width and the first IO speed to internal IO at the second IO width and the second IO speed.

17. The method of claim 16, further comprising:
utilizing a multiplexer and a demultiplexer to convert between external IO at the first IO width and the first IO speed to internal IO at the second IO width and the second IO speed.

18. The method of claim 15, wherein the second IO width is an integer factor of N times the first IO width and the second IO speed is the first IO speed divided by N.

19. The method of claim 18, further comprising:
utilizing a 2:1 multiplexer and a 1:2 demultiplexer to convert between external IO and internal IO where the second IO width is two times the first IO width and the second IO speed is one half of the first IO speed.

20. The method of claim 15, further comprising:
packaging the one or more memory die and the interface module co-located on a same package substrate of the memory package.
